(19) United States
(12) Patent Application Publication
(10) Pub. No.: US 2019/0285912 A1
(43) Pub. Date: Sep. 19, 2019

(54) Eye Protection Lens

(71) Applicant: Kai FANG, Newark, DE (US)

(72) Inventor: Kai FANG, Newark, DE (US)

(73) Assignee: Eyekeeper Global Inc., Newark, DE (US)

(21) Appl. No.: 15/919,214

(22) Filed: Mar. 13, 2018

(51) Int. Cl. G02C 7/10

(52) U.S. Cl. CPC G02C 7/104; G02C 2202/16

(57) ABSTRACT

An eye protection lens includes a lens substrate, a blue light absorbing arrangement, and a lens enhancement arrangement. The blue light absorbing arrangement includes one or more blue light absorbing membranes provided on a surface of the lens substrate for blocking blue light penetrating through the lens substrate. The lens enhancement arrangement is sandwiched between the blue light absorbing arrangement and the lens substrate, wherein the lens enhancement arrangement includes one or more light diffusion membranes for enhancing a rigidity and light transmission of the lens substrate.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention relates to a lens, and more particularly to an eye protection lens and a manufacturing method thereof, wherein a lens enhancement arrangement and a blue light absorbing arrangement are provided on a lens substrate not only to enhance the rigidity and light transmission of the lens substrate, but also to reduce ocular photochemical damage by blocking the blue light penetrating through the lens substrate.

### Description of Related Arts

Electronic devices are indispensable for our daily lives. People use computers for work, play video games and watch TVs during their leisure time and etc. Since many people spend a vast portion of their daily lives fixating on display screens of electronic devices, to protect a viewer's eyesight from excessive usage of any electronic device and prevent eye straining become a dramatic issue nowadays. Accordingly, such LED and computer background light (artificial light sources) are visible light which contains blue light. It has a short wavelength, with high frequency, and can directly penetrate the eye's lenses to the retina. In 40 years ago, scientists have found that the blue lights will damage our eyes. Over the past few decades, blue lights have already confirmed that it have a serious impact on human vision.

Recently, blue lights have a new evidence of making damages to our eyes. Blue lights will increase the light sensitivity of our visual cell and the photo oxidation thereof, so as to cause the death of the visual cells and the damage of our visions. Under aerobic conditions, the retina is stimulated by the blue lights to start the oxidation mechanism, so as to cause a severe oxidation reaction, which destroys the dynamic equilibrium of the oxidation of the body and cause the apoptosis of photoreceptor cells. It is considered that the reaction of the lipofuscin and the blue light are main reasons to cause the degeneration of the macular. A large numbers of experiments show that blue lights are able to activate the oxidation of retinal cells and initiate the apoptosis mechanism thereof, so as to cause the death and damage of the cell.

One of the most important factors in protection of the eyesight for electronic device viewers is to have an intermittent rest for their eyes follow a certain time of use. Another factor in protection of the eyesight for electronic device viewers is to provide a protection arrangement to block the blue light from the electronic device. The protection arrangement can be applied on either the lenses of the eyewear or the screen of the electronic device. However, such protection arrangement has several drawbacks. Accordingly, the protection arrangement will reduce the light transmission of the lens and/or screen such that the viewer will tend to increase the light intensity of the electronic device for increasing the brightness thereof. Especially when the protection arrangement is applied on the lenses of the eyewear, the wearer may feel uncomfortable by darkening the lenses. The protection arrangement can only applied onto the zero-power optical lens but not the long sighted lens, short sighted lens or reading lens. In addition, the protection arrangement does not provide any heat resistance, scratch resistance or strength of the lens or the screen.

### SUMMARY OF THE PRESENT INVENTION

The invention is advantageous in that it provides an eye protection lens and a manufacturing method thereof, wherein a lens enhancement arrangement and a blue light absorbing arrangement are provided on a lens substrate not only to enhance the rigidity and light transmission of the lens substrate, but also to reduce ocular photochemical damage by blocking the blue light penetrating through the lens substrate.

Another advantage of the invention is to provide an eye protection lens and a manufacturing method thereof, wherein the light diffusion membranes are at least one heat resistance membrane, at least one light transmission enhancement membrane, at least one radiation blocking membrane, and at least one ultraviolet light blocking membrane to protect the eyes of the wearer.

Another advantage of the invention is to provide an eye protection lens and a manufacturing method thereof, wherein at least 12 membranes, including the light diffusion membranes and the blue light absorbing membranes, are applied on the surface of the lens substrate. Preferably, 15 membranes are applied on the surface of the lens substrate.

Another advantage of the invention is to provide an eye protection lens and a manufacturing method thereof, wherein the lens substrate is mixed with blue light absorbent for enhancing the blockage of the blue light penetrating through the lens substrate.

Another advantage of the invention is to provide an eye protection lens and a manufacturing method thereof, wherein the light diffusion membranes and the light diffusion membranes are applied on the lens substrate by vapor deposition.

Another advantage of the invention is to provide an eye protection lens and a manufacturing method thereof, wherein the lens substrate can be a zero-power optical lens, a long sighted lens, short sighted lens or reading lens, such that the lens substrate can be incorporated with any existing spectacle.

Another advantage of the invention is to provide an eye protection lens and a manufacturing method thereof, which does not require altering the original structural design of the spectacle, so as to minimize the manufacturing cost of the spectacle that incorporates the eye protection lens.

Another advantage of the invention is to provide an eye protection lens and a manufacturing method thereof, wherein no expensive or complicated structure is required to employ the present invention in order to achieve the above mentioned objectives. Therefore, the present invention successfully provides an economic and efficient solution for enhancing the rigidity and light transmission of the lens substrate, and reducing ocular photochemical damage by blocking the blue light penetrating through the lens substrate.

Additional advantages and features of the invention will become apparent from the description which follows, and may be realized by means of the instrumentalities and combinations particular point out in the appended claims.

According to the present invention, the foregoing and other objects and advantages are attained by an eye protection lens, comprising a lens substrate, a blue light absorbing arrangement, and a lens enhancement arrangement.

The blue light absorbing arrangement comprises one or more blue light absorbing membranes provided on a surface of the lens substrate for blocking blue light penetrating through the lens substrate.

The lens enhancement arrangement is sandwiched between the blue light absorbing arrangement and the lens substrate, wherein the lens enhancement arrangement comprises one or more light diffusion membranes for enhancing a rigidity and light transmission of the lens substrate.

In accordance with another aspect of the invention, the present invention comprises a method for manufacturing an eye protection lens, comprising the following steps.

(A) Make a lens substrate.

(B) Apply a lens enhancement arrangement on a surface of the lens substrate, wherein the lens enhancement arrangement comprises one or more light diffusion membranes for enhancing a rigidity and light transmission of the lens substrate.

(C) Apply a blue light absorbing arrangement on the surface of the lens substrates that the lens enhancement arrangement is sandwiched between the blue light absorbing arrangement and the lens substrate, wherein the blue light absorbing arrangement comprises one or more blue light absorbing membranes provided on the surface of the lens substrate for blocking blue light penetrating through the lens substrate.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a spectacle incorporating with an eye protection lens according to a preferred embodiment of the present invention.

FIG. 2 is an exploded perspective view of the eye protection lens according to the above preferred embodiment of the present invention.

FIG. 3 is a block diagram illustrating a method of manufacturing the eye protection lens according to the above preferred embodiment of the present invention.

FIG. 4 illustrates an alternative mode of the eye protection lens according to the above preferred embodiment of the present invention, illustrating two additional blue light absorbing membranes provided on the lens substrate.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

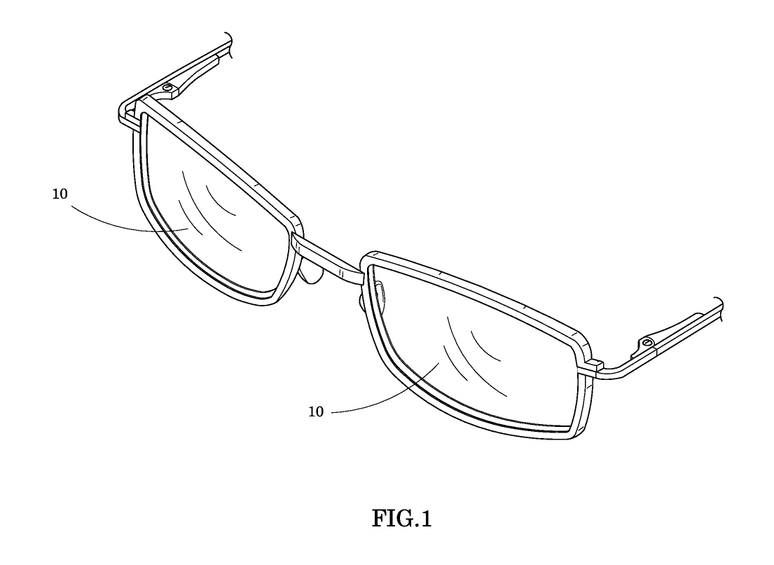

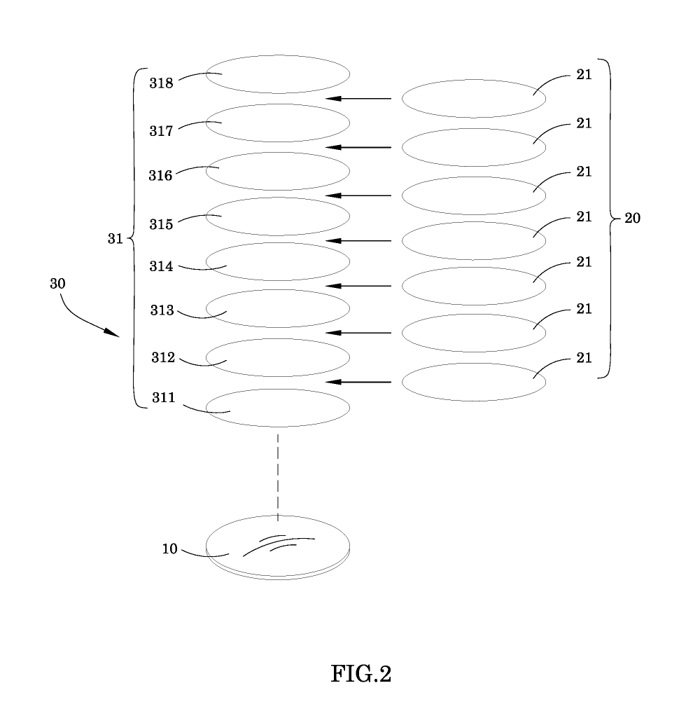

Referring to FIGS. 1 and 2 of the drawings, an eye protection lens according to a preferred embodiment of the present invention is illustrated, wherein the eye protection lens can be incorporated with any existing spectacle frame to form a pair of spectacles as shown in FIG. 1. Accordingly, the eye protection lens comprises a lens substrate 10, a blue light absorbing arrangement 20, and a lens enhancement arrangement 30.

The lens substrate 10 can be a glass substrate or a resin substrate. Preferably, the lens substrate 10 is a yellow tinted lens. The lens substrate 10 is made of resin mixed with blue light absorbent, wherein a weight ratio of the resin and the blue light absorbent in the lens substrate is 1000:3. It is worth mentioning that the lens substrate can be a zero power optical lens, a long sighted lens, short sighted lens or reading lens, such that the lens substrate 10 can be incorporated with any existing spectacle.

The blue light absorbing arrangement 20 comprises one or more blue light absorbing membranes 21 provided on a surface of the lens substrate 10 for blocking blue light penetrating through the lens substrate 10. In particular, the blue light absorbing membranes 21 are applied on an outer surface of the lens substrate 10. Preferably, there are at least seven blue light absorbing membranes 21 applied on the lens substrate 10.

The lens enhancement arrangement 30 is sandwiched between the blue light absorbing arrangement 20 and the lens substrate 10, wherein the lens enhancement arrangement comprises one or more light diffusion membranes 31 for enhancing a rigidity and light transmission of the lens substrate 10. In other words, the blue light absorbing membranes 21 and the light diffusion membranes 31 are applied on the outer surface of the lens substrate 10. It is worth mentioning that the blue light absorbing membranes 21 and the light diffusion membranes 31 can be applied on an inner surface of the lens substrate 10. It should be appreciated that the blue light absorbing membranes 21 and the light diffusion membranes 31 can be applied on two opposite surfaces of the lens substrate 10.

According to the preferred embodiment, the blue light absorbing membranes 21 are alternating with the light diffusion membranes 31 on the surface of the lens substrate 10. In other words, each of the blue light absorbing membranes 21 is sandwiched between every two of adjacent light diffusion membranes 31 as shown in FIG. 2.

According to the preferred embodiment, the lens enhancement arrangement 30 comprises at least one heat resistance membrane, at least one light transmission enhancement membrane, at least one radiation blocking membrane, and at least one ultraviolet light blocking membrane. In other words, the light diffusion membranes are a hardening membrane, at least a SiO₂ membrane, at least a ZrO₂ membrane, a ITO membrane, and a dirt resistance membrane applied on the surface of the lens substrate. The dirt resistance membrane is a film applied on the surface of the lens substrate 10 to prevent any dust or oil attached onto the lens substrate 10, so as to enhance the cleaning ability of the lens substrate 10.

The SiO₂ membrane and the ZrO₂ membrane are embodied as the heat resistance membrane and the light transmission enhancement membrane to enhance the rigidity, heat resistance and light transmission of the lens substrate 10. The ITO membrane is embodied as the radiation blocking and ultraviolet light blocking membrane to block the radiation and ultraviolet through the lens substrate 10. Preferably, the light diffusion membranes 31 are a hardening membrane 311, a first SiO₂ membrane 312, a first ZrO₂ membrane 313, a second SiO₂ membrane 314, a second ZrO₂ membrane 315, a ITO membrane 316, a third ZrO₂ membrane 317, and a dirt resistance membrane 318 applied on the surface of the lens substrate 10 in sequence.

It is worth mentioning that seven blue light absorbing membranes 21 are sandwiched between the light diffusion membranes 31, as shown in FIG. 2. The first blue light absorbing membrane 21 is sandwiched between the hardening membrane 311 and the first SiO₂ membrane 312. The second blue light absorbing membrane 21 is sandwiched between the first SiO₂ membrane 312 and the first ZrO₂ membrane 313. The third blue light absorbing membrane 21 is sandwiched between the first ZrO₂ membrane 313 and the second SiO₂ membrane 314. The fourth blue light absorbing membrane 21 is sandwiched between the second SiO₂ membrane 314 and the second ZrO₂ membrane 315. The fifth blue light absorbing membrane 21 is sandwiched between the second ZrO₂ membrane 315 and the ITO membrane 316. The sixth blue light absorbing membrane 21 is sandwiched between the ITO membrane 316 and third ZrO₂ membrane 317. The seventh blue light absorbing membrane 21 is sandwiched between the third ZrO₂ membrane 317 and the dirt resistance membrane 318.

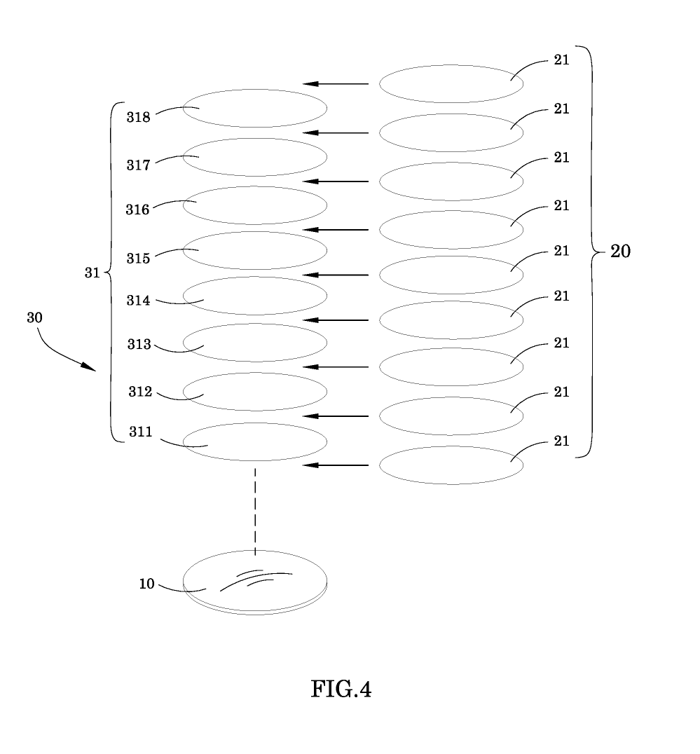

Alternatively, nine blue light absorbing membranes 21 are sandwiched between the light diffusion membranes 31, as shown in FIG. 4. In other words, the eighth blue light absorbing membrane 21 is sandwiched between the lens substrate 10 and the hardening membrane 311. The ninth blue light absorbing membranes 21 is overlapped on the dirt resistance membrane 318.

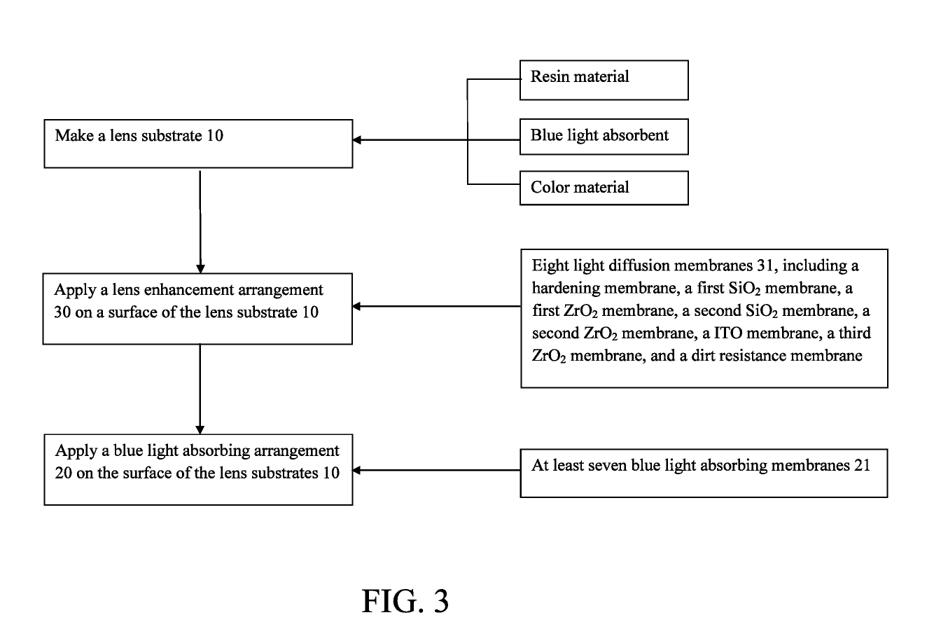

FIG. 3 illustrates a method for manufacturing the eye protection lens which comprises the following steps.

(A) Make the lens substrate 10. Preferably, a raw resin material and a predetermined amount of blue light absorbent are mixed and placed in a mold to form the lens substrate 10. Furthermore, color material is also mixed with the resin material, via dying process or tinting process, to form the yellow tinted lens.

(B) Apply the lens enhancement arrangement 30 on the surface of the lens substrate 10. At least five light diffusion membranes 31, i.e. one hardening membrane, one SiO₂ membrane, one ZrO₂ membrane, one ITO membrane, and one dirt resistance membrane, are applied on the lens substrate 10. Preferably, eight light diffusion membranes 31, i.e. hardening membrane, a first SiO₂ membrane, a first ZrO₂ membrane, a second SiO₂ membrane, a second ZrO₂ membrane, a ITO membrane, a third ZrO₂ membrane, and a dirt resistance membrane, are applied on the lens substrate 10.

(C) Apply the blue light absorbing arrangement 20 on the surface of the lens substrates 10 that the lens enhancement arrangement 30 is sandwiched between the blue light absorbing arrangement 20 and the lens substrate 10. Preferably, seven blue light absorbing membranes 21 are applied on the lens substrate 10.

Accordingly, at least 12 membranes, including seven blue light absorbing membranes 21 and five light diffusion membranes 31, are applied on the lens substrate 10. Preferably, 15 membranes, including seven blue light absorbing membranes 21 and eight light diffusion membranes 31, are applied on the lens substrate 10. The blue light absorbing membranes 21 and the light diffusion membranes 31 are applied on the lens substrate 10 by deposition, especially vapor-deposition. The deposition time for 15 membranes on the lens substrate 10 is two or more hours.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. An eye protection lens, comprising:
a lens substrate;
a blue light absorbing arrangement which comprises one or more blue light absorbing membranes provided on a surface of said lens substrate for blocking blue light penetrating through said lens substrate; and
a lens enhancement arrangement which comprises one or more light diffusion membranes for enhancing a rigidity and light transmission of said lens substrate, wherein said blue light absorbing membranes are alternating with said light diffusion membranes on said surface of said lens substrate.

2. The eye protection lens, as recited in claim 1, wherein said light diffusion membranes are at least one heat resistance membrane, at least one light transmission enhancement membrane, at least one radiation blocking membrane, and at least one ultraviolet light blocking membrane.

3. The eye protection lens, as recited in claim 1, wherein said light diffusion membranes are a hardening membrane, a first SiO₂ membrane, a first ZrO₂ membrane, a second SiO₂ membrane, a second ZrO₂ membrane, a ITO membrane, a third ZrO₂ membrane, and a dirt resistance membrane applied on said surface of said lens substrate in sequence.

4. The eye protection lens, as recited in claim 1, wherein said light diffusion membranes are a combination of a hardening membrane, at least a SiO₂ membrane, at least a ZrO₂ membrane, a ITO membrane, and a dirt resistance membrane applied on said surface of said lens substrate.

5. The eye protection lens, as recited in claim 1, wherein at least seven of said blue light absorbing membranes are deposited on said surface of said lens substrate.

6. The eye protection lens, as recited in claim 1, wherein said lens substrate is made of resin mixed with blue light absorbent.

7. The eye protection lens, as recited in claim 6, wherein a weight ratio of said resin and said blue light absorbent in said lens substrate is 1000:3.

8. The eye protection lens, as recited in claim 1, wherein said lens substrate is selected from a group consisting of a long sighted lens, short sighted lens and reading lens.

9. The eye protection lens, as recited in claim 1, wherein said lens enhancement arrangement and said blue light absorbing arrangement are vapor-deposited on said surface of said lens substrate.

10. The eye protection lens, as recited in claim 1, wherein said lens substrate is a yellow tinted lens.

11. A method for manufacturing an eye protection lens, comprising the steps of:
(a) making a lens substrate;
(b) applying one or more light diffusion membranes on a surface of said lens substrate for enhancing a rigidity and light transmission of said lens substrate; and
(c) applying one or more blue light absorbing membranes provided on said surface of said lens substrate for blocking blue light penetrating through said lens substrate, wherein said blue light absorbing membranes are alternating with said light diffusion membranes on said surface of said lens substrate.

12. The method as recited in claim 11 wherein, in the step (b), said light diffusion membranes are at least one heat resistance membrane, at least one light transmission enhancement membrane, at least one radiation blocking membrane, and at least one ultraviolet light blocking membrane.

13. The method, as recited in claim 11, wherein said light diffusion membranes are a hardening membrane, a first SiO₂ membrane, a first ZrO₂ membrane, a second SiO₂ membrane, a second ZrO₂ membrane, a ITO membrane, a third ZrO₂ membrane, and a dirt resistance membrane applied on said surface of said lens substrate in sequence.

14. The method, as recited in claim 11, wherein said light diffusion membranes and said light diffusion membranes are applied on said surface of said lens substrate by vapor deposition for at least two hours.

15. The method, as recited in claim 11, wherein at least seven of said blue light absorbing membranes are deposited on said surface of said lens substrate.

16. The method as recited in claim 11 wherein, in the step (a) said lens substrate is made of resin mixed with blue light absorbent.

17. The method, as recited in claim 16, wherein a weight ratio of said resin and said blue light absorbent in said lens substrate is 1000:3.

18. The method, as recited in claim 11, wherein said lens substrate is selected from a group consisting of a long sighted lens, short sighted lens and reading lens.

19. The method, as recited in claim 11, wherein there are totally 15 membranes of said light diffusion membranes and said light diffusion membranes being applied on said surface of said lens substrate.

20. The method, as recited in claim 11, wherein said lens substrate is a yellow tinted lens.
